(19) United States
(12) Patent Application Publication
(10) Pub. No.: US 2026/0245219 A1
(43) Pub. Date: Aug. 20, 2026

(54) INFORMATION PROCESSING DEVICE, INFORMATION PROCESSING METHOD, AND PROGRAM

(71) Applicant: Sony Group Corporation, Tokyo (JP)

(72) Inventors: Keisuke Yoshida, Kanagawa (JP); Shohei Noguchi, Tokyo (JP); Yuko Shibaike, Saitama (JP)

(21) Appl. No.: 18/995,032

(22) PCT Filed: Jul. 25, 2023
(86) PCT No.: PCT/JP23/27191

§ 371 Date: Jan. 15, 2025

(30) Foreign Application Priority Data
Aug. 9, 2022 (JP) 2022-127258

(51) Int. Cl. G06T 7/246; H04N 23/63

(52) U.S. Cl. CPC G06T 7/248; H04N 23/635; G06T 2207/30196; G06T 2207/30224

(57) ABSTRACT

Information processing that efficiently performs highly accurate moving object detection is disclosed. In one example, an information processing device calculates a pixel difference of a target frame with respect to a reference frame by selectively calculating a first pixel difference that is a difference between data of an image in a first format corresponding to the reference frame and data of an image in the first format corresponding to the target frame, and a second pixel difference that is a difference between data of an image in a second format having a smaller amount of information than the image in the first format corresponding to the reference frame and data of an image in the second format corresponding to the target frame. The technology can be applied to a digital camera having a continuous imaging function of RAW images.

### TECHNICAL FIELD

The present technology particularly relates to an information processing device, an information processing method, and a program capable of efficiently performing highly accurate moving object detection.

### BACKGROUND ART

There are techniques of performing HDR processing, super-resolution, and the like of RAW images by combining a plurality of RAW images captured continuously.

In a case where a moving object is included in a frame of the image group used for composition, artifacts may occur on the combined image. In particular, artifacts are often generated in portions where they appear due to influences such as leaf flutter or moving objects appearing at the edge of the frame.

At the time of imaging RAW images to be used for composition, since the person who captures an image usually pays attention to a main subject, it is difficult to notice a moving object around the main subject.

Therefore, there are proposed techniques of outputting an alert for letting the person who captures an image realize that a moving object is included during imaging in a case where a moving object is included in a frame. For example, Patent Document 1 discloses a technique for emphasizing a portion of a moving object on a display image.

### CITATION LIST

### Patent Document

Patent Document 1: Japanese Patent Application Laid-Open No. 2017-38837

### SUMMARY OF THE INVENTION

### Problems to Be Solved by the Invention

The moving object detection is performed by calculating pixel differences between the reference frame and each frame.

Normally, for detection of a moving object or the like, images after development in which information is compressed as compared with RAW images are used. In a case where moving object detection is performed using such developed images, detection accuracy of moving objects may be deteriorated.

Although it is conceivable to perform difference calculation using the RAW images as it is in order to improve detection accuracy, it is difficult from the viewpoint of processing load to always perform calculation using information of the entire frames of the RAW images for all frames in the camera and output an alert in real time during imaging.

The present technology has been made in view of such a situation, and enables highly accurate moving object detection to be efficiently performed.

### Solutions to Problems

An information processing device according to one aspect of the present technology includes an image processing unit that calculates a pixel difference of a target frame with respect to a reference frame by selectively calculating a first pixel difference that is a difference between data of an image in a first format corresponding to the reference frame and data of an image in the first format corresponding to the target frame, and a second pixel difference that is a difference between data of an image in a second format having a smaller amount of information than the image in the first format corresponding to the reference frame and data of an image in the second format corresponding to the target frame.

In one aspect of the present technology, a pixel difference of a target frame with respect to a reference frame is calculated by selectively calculating a first pixel difference that is a difference between data of an image in a first format corresponding to the reference frame and data of an image in the first format corresponding to the target frame, and a second pixel difference that is a difference between data of an image in a second format having a smaller amount of information than the image in the first format corresponding to the reference frame and data of an image in the second format corresponding to the target frame.

### BRIEF DESCRIPTION OF DRAWINGS

FIG. 1 is a diagram illustrating an example of a UI screen in an imaging device according to an embodiment of the present technology.

FIG. 2 is a diagram illustrating an example of an image used for difference calculation.

FIG. 3 is a diagram illustrating an example of a region for which difference calculation is performed using RAW image data.

FIG. 4 is a diagram illustrating a display example of information indicating a progress status of continuous imaging.

FIG. 5 is a block diagram illustrating a configuration example of an imaging device.

FIG. 6 is a diagram illustrating an example of metadata added to RAW images.

FIG. 7 is a flowchart for explaining continuous imaging processing of RAW images.

FIG. 8 is a flowchart for explaining main imaging processing performed in step S9 in FIG. 7.

FIG. 9 is a flowchart for explaining captured number calculation processing.

FIG. 10 is a block diagram illustrating a configuration example of a PC.

FIG. 11 is a diagram illustrating an example of thumbnail images displayed on a selection screen.

FIG. 12 is a diagram illustrating an example of a moving object determination difficult region.

FIG. 13 is a diagram illustrating an example of alert display.

FIG. 14 is a diagram illustrating an example of camera shake information.

FIG. 15 is a diagram illustrating an example of an imaging control system.

### MODE FOR CARRYING OUT THE INVENTION

Hereinafter, modes for carrying out the present technology will be described. The description will be given in the following order.
1. Moving Object Determination Mode
2. Configuration of Imaging Device
3. Operation of Imaging Device
4. Modifications

### Moving Object Determination Mode

### Alert Display Function of Moving Object Region

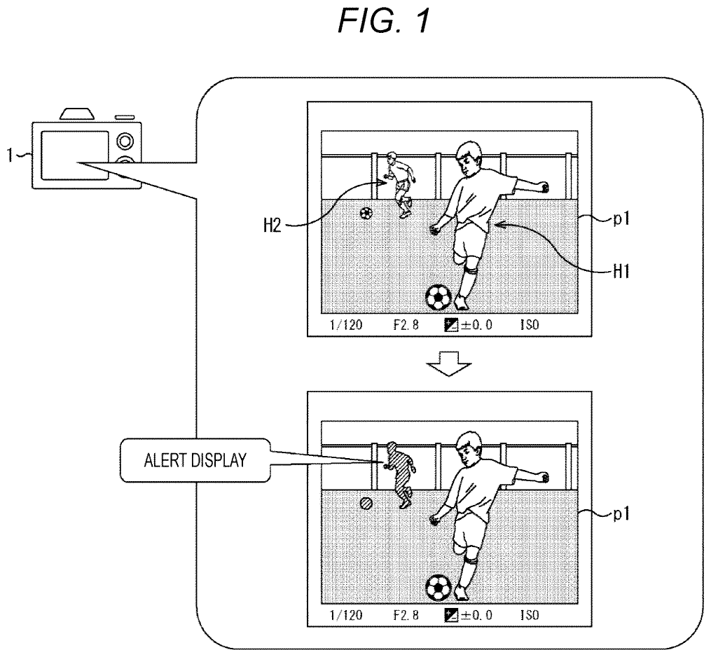

FIG. 1 is a diagram illustrating an example of a UI screen in an imaging device according to an embodiment of the present technology.

An imaging device 1 illustrated in FIG. 1 is a digital camera having a continuous imaging function of RAW images. For example, during a period from when the user presses the shutter button until imaging of a predetermined number of RAW images is completed, imaging of RAW images is continuously performed.

The plurality of RAW images continuously captured is stored in, for example, the memory of the imaging device 1, and is captured by an external device such as a PC. In the PC that has captured the RAW image, combining processing of a plurality of RAW images is performed. By the combining processing, an HDR-processed RAW image (RAW image with extended dynamic range of luminance) or a super-resolved RAW image (RAW image with increased number of pixels) is generated.

As described above, the continuous imaging function of the imaging device 1 is used, for example, to image RAW images used for post-imaging composition. In a case where a moving object is present in a RAW image used for composition, an artifact may occur in an image generated by the combining processing. The imaging device 1 is equipped with a support function for imaging a RAW image in which no moving object is present.

In a case where the user who is the person who captures an image turns on the continuous imaging function and directs the imaging device 1 toward the subject, a UI screen including a live view (LV) image p1 is displayed on a monitor or an electronic view finder (EVF) provided on the back surface of the housing of the imaging device 1 as illustrated in the upper part of FIG. 1.

In the example of FIG. 1, a person H1 playing soccer on the ground is present as a main subject substantially at the center of the LV image p1. In addition, a person H2 playing soccer behind the person H1 is present at the upper left end of the LV image p1. The user considers the composition and the timing of pressing the shutter button while viewing such an LV image p1. Below the LV image p1, information of imaging parameters such as a shutter speed and an aperture value is displayed.

For example, in a case where the user performs a predetermined trigger operation by half-pressing the shutter button or the like, the moving object determination processing is started. The moving object determination processing is processing of determining whether or not a moving object is present in the image being captured.

In a case where a moving object is detected in the image being captured, an alert display for notifying the user that the moving object is present is performed as illustrated in the lower part of FIG. 1. In the example of FIG. 1, the alert display is performed by emphasizing the region of the person H2 and the region of the ball at the foot of the person H2. The emphasized display of the moving object region, which is the region in which the moving object is present, is performed, for example, using alert information such as an image of a predetermined pattern such as zebra pattern or an image of a predetermined color.

By performing such alert display, the user can notice that a moving object is present in the image being captured. The user can press the shutter button from the half-pressed state at a timing when there are few moving bodies or vibrating bodies and perform continuous imaging of RAW images.

Note that, even if a moving object is present, for example, the alert display is not performed for a focused region. Since it is less likely to notice that there is a moving object in an unfocused region, the alert display is performed in a case where the moving object is present in a region other than the focused region. In the example of FIG. 1, the person H1 is a moving object, but an alert display is not performed because the person H1 is focused as a main subject. As will be described later, it is possible to designate a region in which the alert display is performed in a case where a moving object is present.

The moving object determination processing is performed by performing difference calculation between pixels of the reference frame and each frame captured after the reference frame and determining a region having a difference as a moving object region. For example, a frame (image) captured when the user performs a trigger operation is selected as the reference frame.

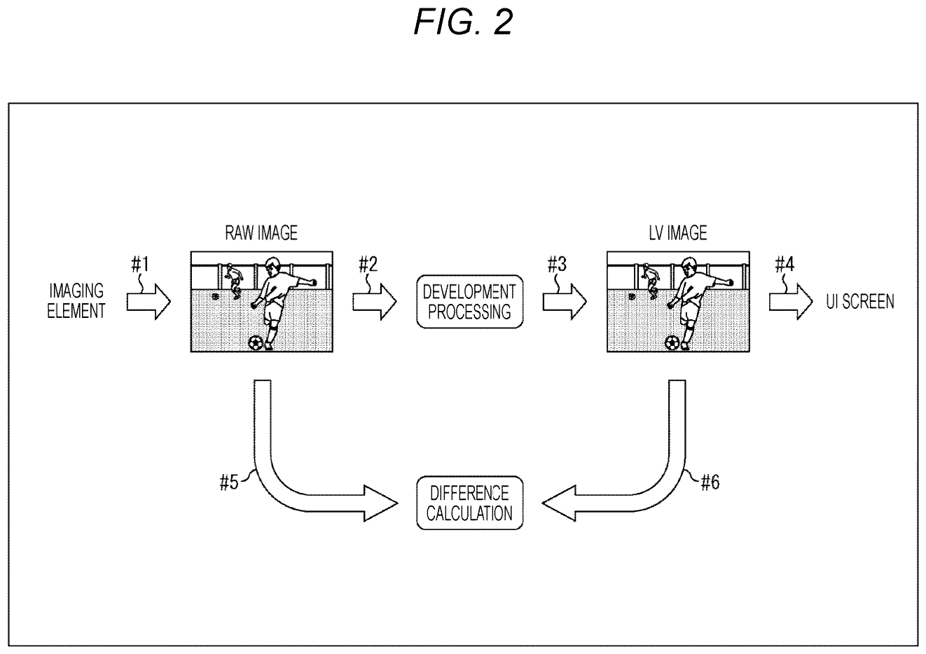

FIG. 2 is a diagram illustrating an example of an image used for difference calculation.

In a case where a frame to be subjected to difference calculation with respect to the reference frame is captured, as indicated by a portion pointed by an arrow #1, a RAW image including pixel data read from each pixel of the imaging element is generated.

For example, in a case where the imaging element is a Bayer array image sensor, the RAW image is an image including pixel values of pixels of G1 (green 1), G2 (green 2), R (red), and B (blue). A YC-RAW image, which is an image in which pixel values read from the imaging element are in the form of a luminance value and a chroma value, may be generated as a RAW image. An arbitrary format can be adopted as the format of the RAW image.

As indicated by a portion pointed by an arrow #2, development processing is performed on the RAW image, and an LV image (live view image) indicated by a portion pointed by an arrow #3 is generated as a developed image. Various types of processing such as lens correction, noise reduction, color reproduction processing, sharpness processing, and compression processing are performed as development processing. The LV image in a format different from the RAW format generated by the development processing is used to display the UI screen as indicated by a portion pointed by an arrow #4.

As described above, in a case where a certain frame is captured, two types of images of a RAW image and an LV image are generated as images of the frame in the imaging device 1. The difference calculation in the moving object determination processing is performed by selectively switching the RAW image data and the LV image data according to the scene as indicated by a portion pointed by arrows #5 and #6.

Each of the RAW image and the LV image has the following features.
Features of RAW image

Since both the pixels and the grayscale are not compressed (the amount of information is not reduced), the difference calculation using the RAW image data is highly accurate calculation. However, since the calculation load is high, it is difficult to always perform the difference calculation using the RAW image data in the imaging device 1.
Features of LV image

Since both the pixels and the grayscale are compressed, the difference calculation using the LV image data is less accurate than a case using the RAW image data. However, since the calculation load is low, difference calculation using the LV image data can be always performed in the imaging device 1.

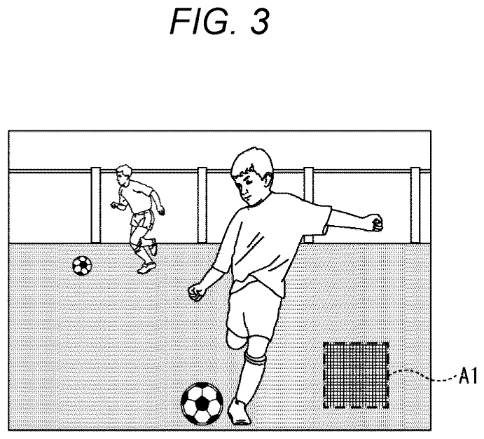

FIG. 3 is a diagram illustrating an example of a region for which difference calculation is performed using RAW image data.

Basically, the LV image data is used for difference calculation with the reference frame. The difference calculation is performed so as to obtain the difference between the pixels in the corresponding region on the basis of the LV image data of the reference frame and the LV image data of the target frame.

Meanwhile, in a case where a moving object determination difficult region is included in the frame to be subjected to the difference calculation from the reference frame, the RAW image data is used for the difference calculation of the moving object determination difficult region. On the basis of the RAW image data of the reference frame and the RAW image data of the target frame, a difference calculation is performed so as to obtain a difference in the moving object determination difficult region.

In the example of FIG. 3, a lower right region Al of a frame to be subjected to difference calculation is detected as a moving object determination difficult region. The RAW image data is used for the difference calculation of the region Al, and the LV image data is used for the difference calculation of the region other than the region Al. As described above, the region for which the difference calculation is performed using the RAW image data and the region for which the difference calculation is performed using the LV image data are set to be mixed in the frames to be subjected to the difference calculation.

As the moving object determination difficult region, a region in which it is difficult to determine a moving object with data with a small amount of information, such as a region in which a high-frequency subject appears (a region of pixels including high-frequency components), a region in which a strong-edge subject appears (a region of pixels including high-edge components), and a region in which a high-luminance subject appears (a region of pixels including high-luminance components), is detected. The moving object determination difficult region may be detected on the basis of at least one of whether or not the region is a region of pixels including high-frequency components, whether or not the region is a region of pixels including strong-edge components, or whether or not the region is a region of pixels including high luminance components.

In the example of FIG. 3, a region in which a subject with a fine pattern such as lawn on the ground appears is detected as a moving object determination difficult region. In a case where the LV image data having a small information amount is used for the difference calculation in the moving object determination difficult region, sufficient accuracy may not be secured as the accuracy of the difference calculation. By using the RAW image data for the difference calculation of the moving object determination difficult region, it is possible to perform highly accurate difference calculation.

In addition, it is difficult to always use the RAW image data for difference calculation of the entire frames from the viewpoint of processing load. The difference calculation, that is, the moving object detection can be efficiently performed by using the RAW image data only for the difference calculation of the moving object determination difficult region and using the LV image data for the difference calculation of the other regions.

In a case where the moving object is detected by the difference calculation using the LV image data or the RAW image data, the alert display is performed as described above.

### Automatic Calculation Function of Number of Captured Images

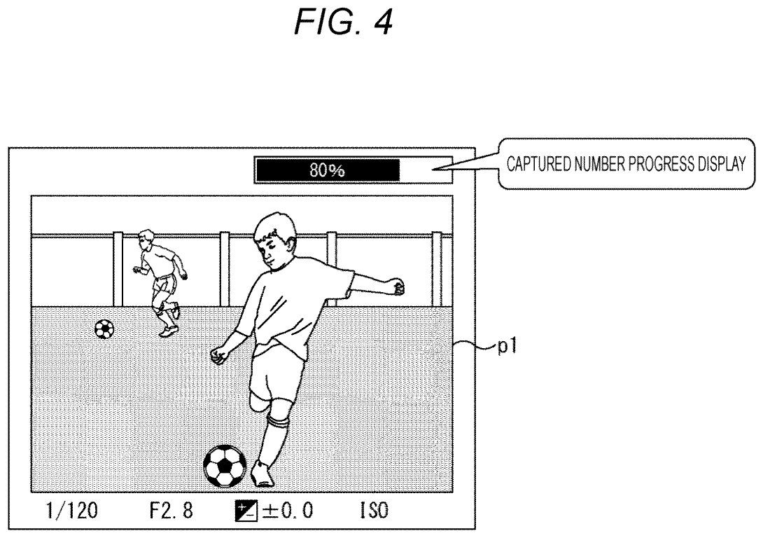

FIG. 4 is a diagram illustrating a display example of information indicating a progress status of continuous imaging.

In a case where continuous imaging of RAW images is started by pressing the shutter button, the number of captured RAW images is dynamically determined by the imaging device 1 as described later. Furthermore, information indicating the progress status of the continuous imaging is displayed on the UI screen and presented to the user.

For example, as illustrated in FIG. 4, a progress bar indicating the progress status of the continuous imaging is displayed at the upper right of the UI screen. In the example of FIG. 4, the progress bar indicates that “80%” of the entire imaging is completed. In a case where the display of the progress bar indicates “100%”, the continuous imaging ends.

After starting the continuous imaging of the RAW image, the user can check the progress status of the continuous imaging by checking the display of the progress bar.

A series of processing of the imaging device 1 including the alert display and the processing of automatic calculation of the number of captured images as described above will be described later with reference to flowcharts.

### Configuration of Imaging Device

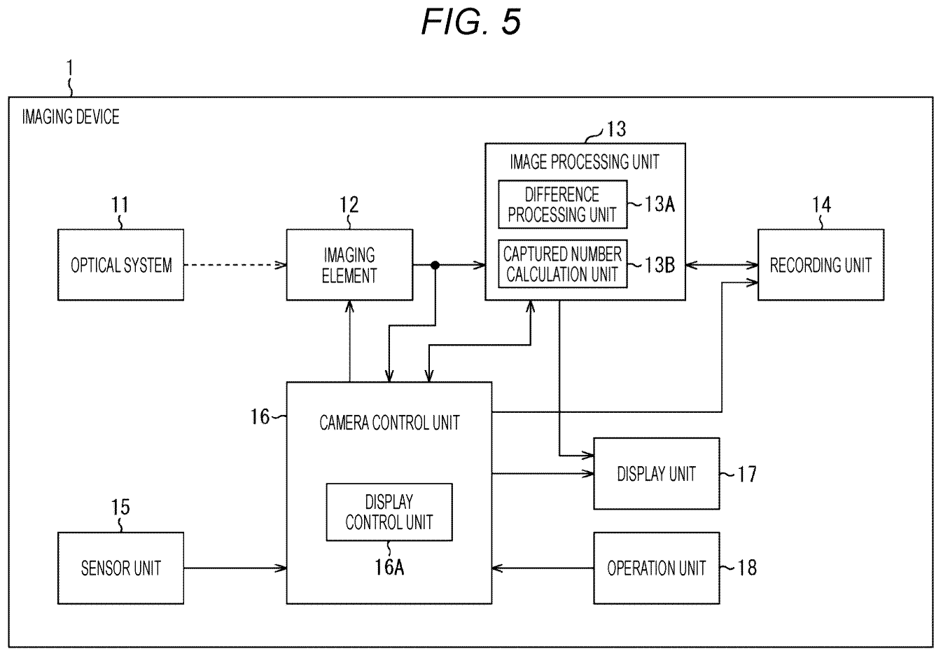

FIG. 5 is a block diagram illustrating a configuration example of the imaging device 1.

As illustrated in FIG. 5, the imaging device 1 includes an optical system 11, an imaging element 12, an image processing unit 13, a recording unit 14, a sensor unit 15, a camera control unit 16, a display unit 17, and an operation unit 18.

The optical system 11 includes optical system members such as lenses such as a zoom lens and a focus lens, and an aperture mechanism. Light from a subject is guided to the imaging element 12 by the optical system 11.

The imaging element 12 includes a complementary metal oxide semiconductor (CMOS) image sensor or the like. The imaging element 12 performs various types of processing such as automatic gain control (AGC) processing and analog/digital (A/D) conversion processing on a signal obtained by performing photoelectric conversion. Image data generated by performing various types of processing is supplied to the image processing unit 13 and the camera control unit 16.

The image processing unit 13 includes an image processing processor such as a digital signal processor (DSP). The image processing unit 13 acquires the image data supplied from the imaging element 12 as RAW image data. In a case where the YC-RAW image is used as the RAW image as described above, processing of generating the YC-RAW image on the basis of the image data supplied from the imaging element 12 is appropriately performed in the image processing unit 13.

Furthermore, the image processing unit 13 performs development processing to generate an LV image on the basis of the RAW image. The LV image generated by the image processing unit 13 is supplied to the display unit 17 and used for displaying the UI screen. As described above, in the image processing unit 13, the RAW image data and the LV image data are acquired as the data of each frame captured by the imaging element 12.

Before starting the continuous imaging, the image processing unit 13 outputs the RAW image data of the reference frame of the moving object determination processing to the recording unit 14 to temporarily record the data. Furthermore, after the continuous imaging is started, the image processing unit 13 outputs the RAW image data of each frame to the recording unit 14 to record the data.

In the image processing unit 13, a difference processing unit 13A and a captured number calculation unit 13B are implemented by executing a predetermined program.

The difference processing unit 13A selects and analyzes each frame captured after the reference frame as a determination target frame to be subjected to the moving object determination processing. By the analysis processing, a region in which a high-frequency subject appears or the like is detected as a moving object determination difficult region.

In addition, the difference processing unit 13A calculates a difference between the reference frame and each determination target frame, and performs moving object determination processing. As described above, the difference calculation by the difference processing unit 13A is performed such that the RAW image data is used for the moving object determination difficult region and the LV image data is used for the region other than the moving object determination difficult region. The difference processing unit 13A determines data to be used for difference calculation according to a predetermined condition such as whether or not the determination target frame includes the moving object determination difficult region.

Information indicating a result of the moving object determination processing is supplied from the difference processing unit 13A to the camera control unit 16. For example, in a case where a moving object is detected, information of a region where the moving object appears is supplied to the camera control unit 16. Furthermore, in a case where a moving object determination difficult region is detected, the information of the moving object determination difficult region is supplied to the camera control unit 16.

After the continuous imaging is started, the captured number calculation unit 13B calculates the number of continuous imaging. When the number of RAW images calculated by the captured number calculation unit 13B is recorded, the continuous imaging ends.

The recording unit 14 includes a recording medium such as a memory, and temporarily records the RAW image data of the reference frame supplied from the image processing unit 13. The recording unit 14 functions as a buffer for RAW image data. The data temporarily recorded in the recording unit 14 is used for difference calculation by the difference processing unit 13A.

Furthermore, the recording unit 14 records the RAW image data supplied from the image processing unit 13 after the start of continuous imaging.

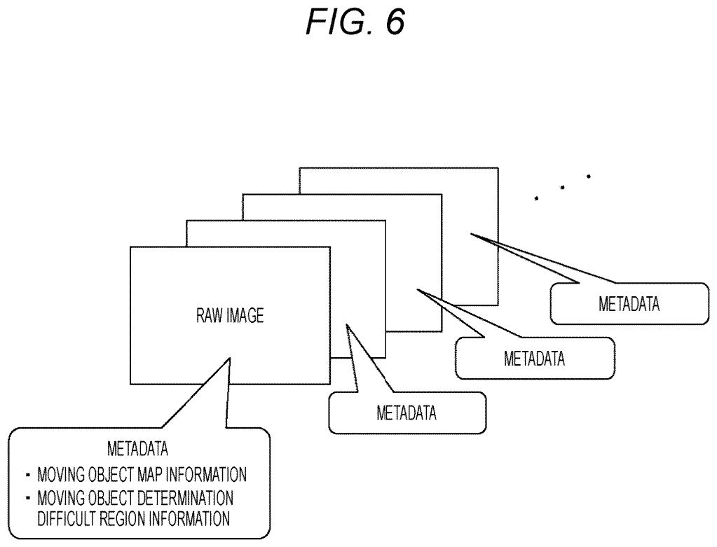

FIG. 6 is a diagram illustrating an example of metadata added to RAW images.

As illustrated in FIG. 6, metadata including moving object map information and moving object determination difficult region information is added to data of each RAW image obtained by continuous imaging by the camera control unit 16.

The moving object map information is information indicating a region in which a moving object appears in a case where the moving object is detected in the frame. The moving object determination difficult region information is information indicating a moving object determination difficult region in a case where the moving object determination difficult region is detected in the frame. The moving object map information and the moving object determination difficult region information are used in an external device such as a PC that has read RAW image data.

Returning to the description of FIG. 5, the sensor unit 15 includes various sensors such as a gyro sensor, an acceleration sensor, a distance sensor, and a positioning sensor. Sensor data indicating a measurement result by the sensor unit 15 is supplied to the camera control unit 16. A measurement result by a gyro sensor or the like is appropriately used for the automatic calculation of the number of captured images described above.

The camera control unit 16 includes a CPU, a ROM, a RAM, and the like. The camera control unit 16 executes a predetermined program and controls the entire operation of the imaging device 1 according to a user's operation or the like.

For example, the camera control unit 16 controls the image processing unit 13 to perform continuous imaging of RAW images. On the basis of the information supplied from the difference processing unit 13A, the camera control unit 16 causes the recording unit 14 to record data of each RAW image to which metadata including moving object map information and moving object determination difficult region information has been added. The camera control unit 16 functions as a control unit that records metadata including moving object map information and moving object determination difficult region information in association with a RAW image.

In the camera control unit 16, a display control unit 16A is implemented by executing a predetermined program.

The display control unit 16A causes the display unit 17 to display various screens such as the UI screen as described above. For example, in a case where a moving object is detected before the start of continuous imaging, the display control unit 16A performs alert display of the moving object region by displaying information of a predetermined color in superimposition on the LV image or the like.

The display unit 17 includes a display provided on the back surface of the housing and a display constituting the EVF. The display unit 17 displays various types of information such as the LV image supplied from the image processing unit 13 under the control of the camera control unit 16.

The operation unit 18 includes various buttons such as a shutter button provided on the housing of the imaging device 1, a touch panel provided on a display constituting the display unit 17, and the like. The operation unit 18 outputs information indicating the content of the user's operation on the button or the touch panel to the camera control unit 16.

### Operation of Imaging Device

Here, the operation of the imaging device 1 having the above configuration will be described.

### Continuous Imaging Processing

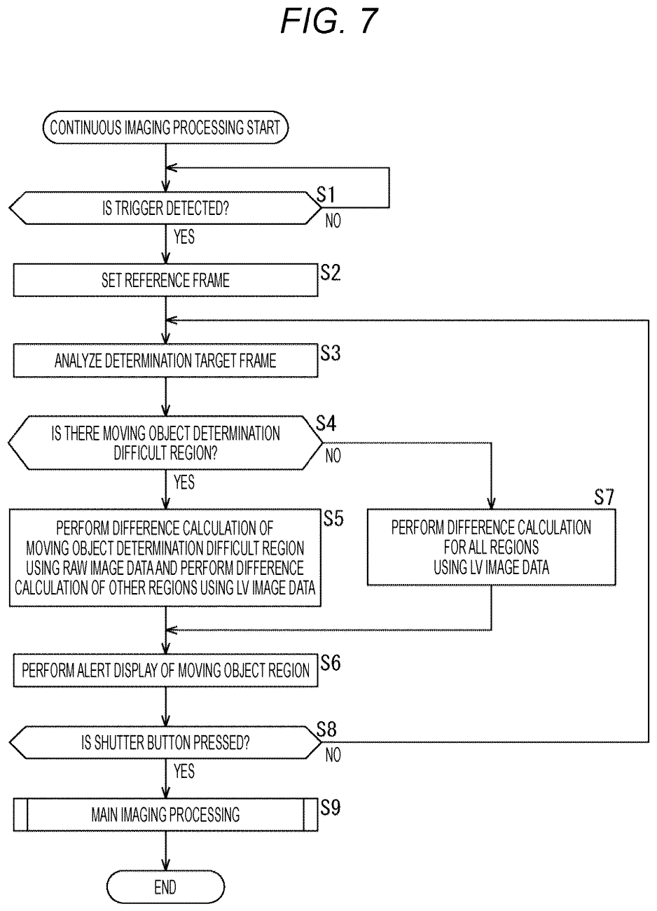

The continuous imaging processing of RAW images will be described with reference to the flowchart of FIG. 7.

The continuous imaging processing mainly includes pre-imaging processing before start of main imaging (continuous imaging) and processing after start of main imaging. In the pre-imaging processing from step S1 to step S8, the RAW image is not recorded. The processing of FIG. 7 is started, for example, when the user turns on the power of the imaging device 1 and sets the continuous imaging mode of the RAW image.

In step S1, the camera control unit 16 determines whether or not a trigger such as half-pressing of the shutter button has been detected, and standbys until it is determined that the trigger has been detected. In a case where it is determined in step S1 that the trigger is detected, the processing proceeds to step S2.

In step S2, the difference processing unit 13A of the image processing unit 13 sets a reference frame for moving object determination processing.

In step S3, the difference processing unit 13A analyzes the determination target frame captured subsequently to the reference frame.

In step S4, the difference processing unit 13A determines whether or not a moving object determination difficult region is included in the determination target frame.

In a case where it is determined in step S4 that the moving object determination difficult region is included in the determination target frame, in step S5, the difference processing unit 13A performs difference calculation of the moving object determination difficult region using the RAW image data and performs difference calculation of the other regions using the LV image data.

In step S6, in a case where a moving object is detected, the display control unit 16A performs alert display of the moving object region.

Meanwhile, in a case where it is determined in step S4 that the moving object determination difficult region is not included in the determination target frame, in step S7, the difference processing unit 13A performs difference calculation for all the regions using the LV image data. After the difference calculation using the LV image data is performed, the processing proceeds to step S6, and in a case where a moving object is detected in the determination target frame, the alert display of the moving object region is performed.

In step S8, the camera control unit 16 determines whether or not the shutter button has been pressed. In a case where it is determined that the shutter button is not pressed, the processing returns to step S3, and the above-described processing is repeatedly performed.

Meanwhile, in a case where it is determined in step S8 that the shutter button has been pressed, the main imaging processing is started in step S9.

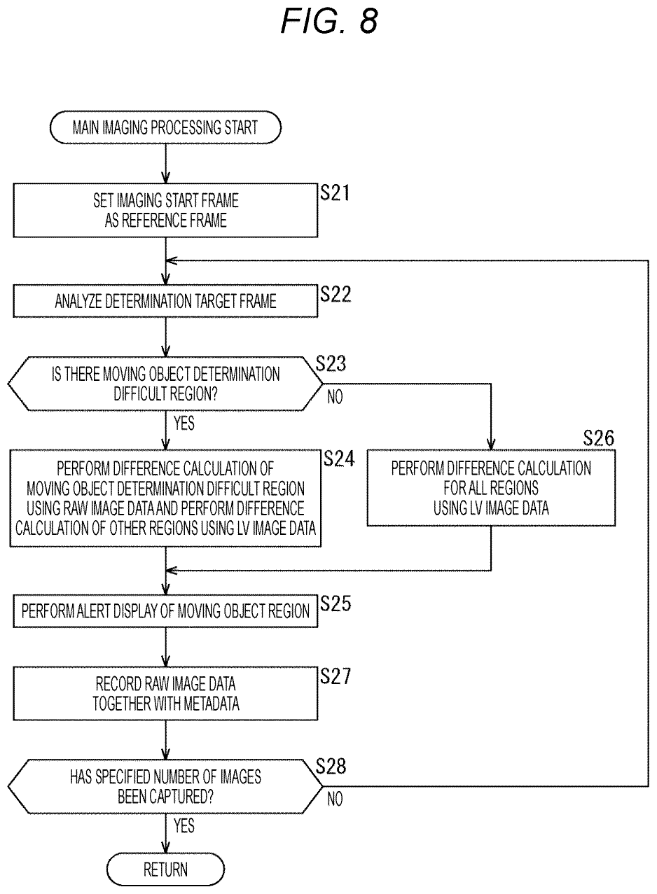

The main imaging processing performed in step S9 in FIG. 7 will be described with reference to the flowchart in FIG. 8.

In step S21, the difference processing unit 13A sets the imaging start frame as the reference frame. A frame captured immediately after the shutter button is pressed is set as the reference frame.

In step S22, the difference processing unit 13A analyzes the determination target frame.

In step S23, the difference processing unit 13A determines whether or not a moving object determination difficult region is included in the determination target frame.

In a case where it is determined in step S23 that the moving object determination difficult region is included in the determination target frame, in step S24, the difference processing unit 13A performs difference calculation of the moving object determination difficult region using the RAW image data and performs difference calculation of the other regions using the LV image data.

In step S25, in a case where a moving object is detected, the display control unit 16A performs alert display of the moving object region.

Meanwhile, in a case where it is determined in step S23 that the moving object determination difficult region is not included in the determination target frame, in step S26, the difference processing unit 13A performs difference calculation for all the regions using the LV image data. After the difference calculation using the LV image data is performed, the processing proceeds to step S25, and in a case where a moving object is detected in the determination target frame, the alert display of the moving object region is performed.

In step S27, the recording unit 14 causes the recording unit 14 to record the RAW image data together with the metadata.

In step S28, the camera control unit 16 determines whether or not the specified number of images has been captured. The number of images serving as a reference for determination is appropriately obtained by automatic calculation by the captured number calculation unit 13B. In a case where it is determined in step S28 that the specified number of images has not been captured, the processing returns to step S22, and the above processing is repeatedly performed.

Meanwhile, in a case where it is determined in step S28 that the specified number of images has been captured, the processing returns to step S9 in FIG. 7, and the continuous imaging processing ends.

### Captured Number Calculation Processing

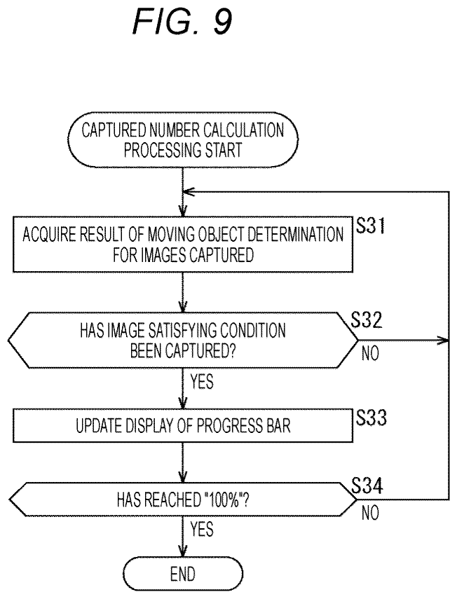

Next, captured number calculation processing will be described with reference to the flowchart of FIG. 9. The processing of FIG. 9 is performed in parallel with the main imaging processing of FIG. 8, for example.

In step S31, the captured number calculation unit 13B of the image processing unit 13 acquires the result of the moving object determination by the difference processing unit 13A for the RAW image captured by the continuous imaging. The subsequent processing may be performed on the premise that the RAW image including no moving object is imaged.

In step S32, the captured number calculation unit 13B determines whether or not a RAW image satisfying the condition has been captured.

As the RAW image satisfying the condition, for example, the following images are set according to the purpose.
(A) Case where specified number of images is set in advance

In a case where imaging is performed until a specified number of RAW images set in advance not including a moving object can be acquired, the RAW image not including a moving object is an image that satisfies the condition. A specified number of images such as 10 images is set in advance.
(B) Case of performing calculation with pixel coverage

In a case where imaging is performed using camera shake by the user until all information of positions shifted by 0.5 to 1 pixels can be acquired on the imaging element 12, for example, a RAW image shifted by a predetermined pixel with respect to the position of the reference frame is an image that satisfies the condition. The condition (B) is a condition assuming hand-held imaging. For example, the condition (B) is set in a case where super-resolution is performed as combining processing after imaging.
(C) Case of performing calculation based on coverage of exposure level

In a case where imaging is performed until all the RAW images (0 EV/±1 EV/±2 EV/ . . . ) at the set exposure level can be acquired, the RAW image at the set exposure level is an image that satisfies the condition. The condition (C) is a condition used in a case of performing exposure bracket imaging for performing continuous imaging while changing the setting of the exposure level. For example, the condition (C) is set in a case where HDR processing is performed as combining processing after imaging.

In a case where it is determined in step S32 that the RAW image satisfying the condition has not been captured, the processing returns to step S31, and the above-described processing is repeated.

Meanwhile, in a case where it is determined in step S33 that the RAW image satisfying the condition has been captured, in step S33, the display control unit 16A updates the display of the progress bar indicating the progress status of the continuous imaging.

In step S34, the camera control unit 16 determines whether or not the display of the progress bar has reached a state indicating “100%”. In a case where it is determined in step S34 that the progress bar has not reached the display of “100%”, the processing returns to step S31, and the above-described processing is repeatedly performed.

Meanwhile, in a case where it is determined in step S34 that the progress bar has reached the display of “100%”, the camera control unit 16 stops the continuous imaging and ends the captured number calculation processing.

As described above, at the time of continuous imaging of RAW images and before the start of the continuous imaging, a moving object included in a frame is detected, and in a case where a moving object is included, alert display is performed. As a result, the user can predict the timing at which there are few moving bodies in the frame, and start the continuous imaging at the timing at which no moving object is included in the frame. The user can image a RAW image that does not include a moving object. In a case where the user determines the timing at which a moving object is not included by himself/herself by looking at the LV image, there is a case where a moving object present at the edge of the frame or a small moving object is missed, but such a case can be prevented.

By capturing a RAW image that does not include a moving object, it is possible to reduce the risk of failure in the combining processing of RAW images.

In addition, the LV image data and the RAW image data are switched and used according to the scene for difference calculation in the moving object determination processing. As a result, the imaging device 1 can efficiently perform the difference calculation with high accuracy in real time.

The information on the moving object region and the information on the moving object determination difficult region are imparted as metadata to the captured RAW image data. An external device such as a PC that captures a RAW image captured by the imaging device 1 can utilize the information at the time of post-imaging composition.

Since the continuous imaging is ended at the timing when the number of RAW images determined dynamically can be acquired, it is possible to efficiently image RAW images suitable for the combining processing. There is a case where it is not possible to obtain all the images required for the combining processing only by imaging the specified number of RAW images set in advance, but such a situation can be prevented.

In a case where continuous imaging is performed by hand-held imaging, a camera shake amount may be calculated on the basis of sensor data output from a gyro sensor constituting the sensor unit 15, and the moving object determination may be performed only when the camera shake amount is equal to or less than a threshold. For example, in a case where the camera shake amount exceeds the threshold, the continuous imaging is forcibly terminated.

In a case where the camera shake amount is large, it is difficult to determine the moving object. By performing the moving object determination only when the camera shake amount is equal to or less than the threshold, the accuracy of the moving object determination can be enhanced.

### Modifications

### Utilization of Moving Object Map Information and Moving Object Determination Difficult Region Information

In an external device such as a PC that captures a RAW image captured by the imaging device 1, various types of processing such as combining processing are performed. The moving object map information and the moving object determination difficult region information included in the metadata are appropriately used in an external device.

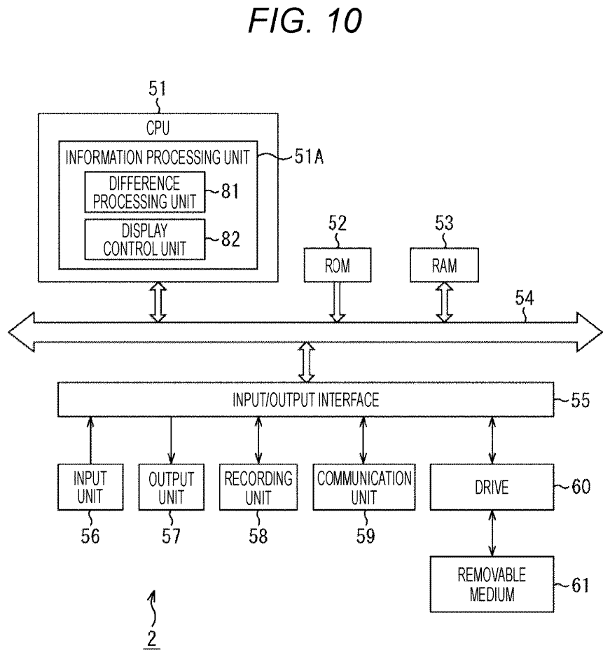

FIG. 10 is a block diagram illustrating a configuration example of a PC.

A PC 2 illustrated in FIG. 10 is an external device that performs various types of processing using RAW images captured by the imaging device 1. As illustrated in FIG. 10, the CPU 51, the ROM 52, and the RAM 53 are mutually connected by a bus 54.

An input/output interface 55 is further connected to the bus 54. An input unit 56 including a keyboard, a mouse, and the like, and an output unit 57 including a display, a speaker, and the like are connected to the input/output interface 55. Furthermore, a recording unit 58 including a hard disk, a nonvolatile memory, or the like, a communication unit 59 including a network interface or the like, and a drive 60 that drives a removable medium 61 are connected to the input/output interface 55. The RAW image data captured from the imaging device 1 is recorded in the recording unit 58.

In the PC 2 configured as described above, the CPU 51 executes, for example, a program recorded in the recording unit 58, thereby implementing an information processing unit 51A. The information processing unit 51A includes a difference processing unit 81 and a display control unit 82.

The difference processing unit 81 performs difference calculation between the reference frame and the determination target frame on the basis of the RAW images captured by the imaging device 1. For example, the difference processing unit 81 specifies the moving object determination difficult region on the basis of the moving object determination difficult region information added to each RAW image, and performs difference calculation of the moving object determination difficult region using RAW image data.

As described above, since the information of the moving object determination difficult region is added as metadata, the PC 2 can perform pinpoint difference calculation of the moving object determination difficult region. Since the processing capability of the CPU 51 is higher than the processing capability of the imaging device 1, the PC 2 can easily perform difference calculation using the RAW image data.

The display control unit 82 causes the display to display a RAW image selection screen to be used for the combining processing. The user selects the RAW image to be used for the combining processing by viewing the thumbnail image and the like displayed on the selection screen.

When the selection screen is displayed, the display control unit 82 specifies a moving object region on the basis of moving object map information added to each RAW image and performs alert display.

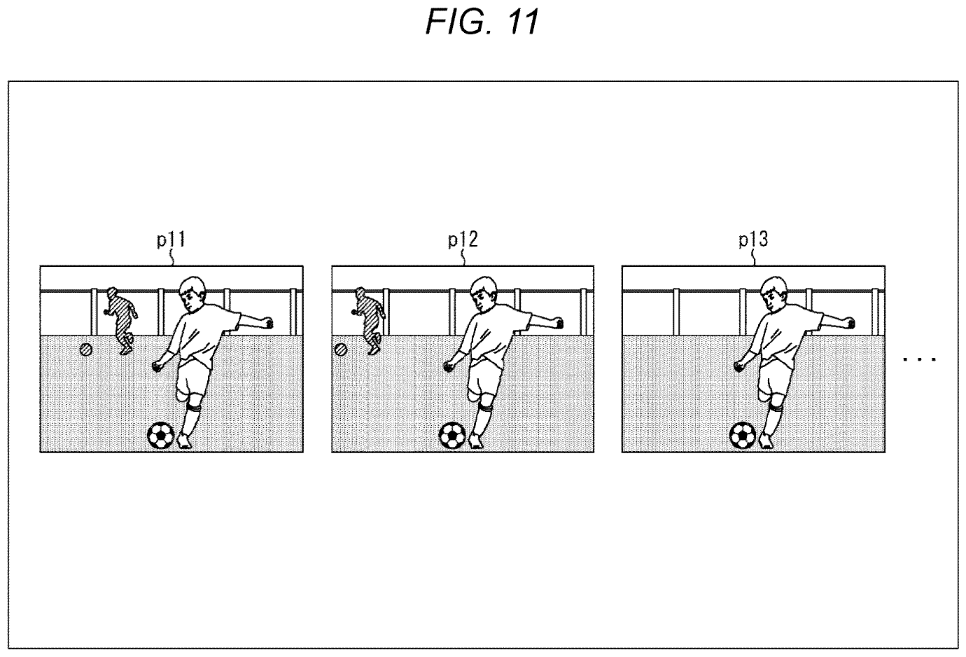

FIG. 11 is a diagram illustrating an example of thumbnail images displayed on the selection screen.

In the example of FIG. 11, three thumbnail images p11 to p13 are displayed side by side. Since a moving object is present at the upper left, alert display is performed for the moving object regions of the image p11 and the image p12. In this way, by presenting the information of the moving object region, the user can easily select an image in which no moving object is present as the RAW image to be used for composition.

The area of the moving object region may be calculated on the basis of the moving object map information, and the RAW image to be used for composition may be automatically selected by the PC 2. In this case, for example, a RAW image in which the area of the moving object region is equal to or less than the threshold is selected as the RAW image to be used for composition.

### Example of Image Data Used for Difference Calculation

The difference calculation using the LV image data is basically performed, and in a case where the moving object determination difficult region is included, the difference determination is performed using the RAW image data. However, the image data used for the difference calculation may be selected as follows.
Example in which difference calculation of moving object determination difficult region is performed using LV image data

A high calculation load is required for difference determination using RAW image data. Therefore, in a case where the range of the moving object determination difficult region is wide, the calculation load also increases.

In order to suppress the calculation load of the imaging device 1, in a case where the area of the moving object determination difficult region exceeds the threshold, difference calculation in a range in which the area is within the threshold in the moving object determination difficult region may be performed using the RAW image data, and difference calculation in other ranges may be performed using the LV image data. Data to be used for difference calculation is determined according to whether or not the area of the moving object determination difficult region is equal to or larger than the threshold.

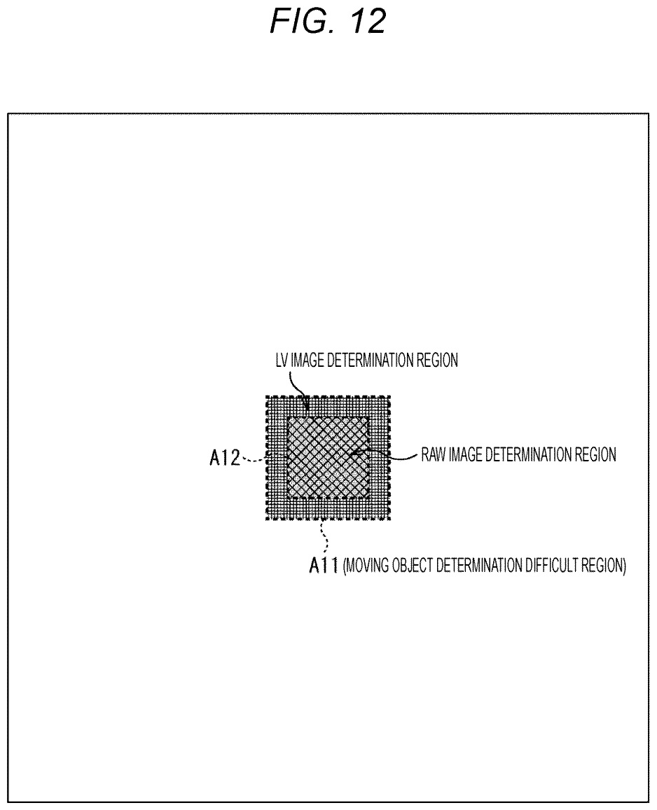

FIG. 12 is a diagram illustrating an example of a moving object determination difficult region.

In the example of FIG. 12, a region A11 is detected as a moving object determination difficult region. The area of the region A11 is larger than the threshold area. In this case, the difference calculation of the region A12, which is a region having an area within the threshold, is performed using the RAW image data. In the region A11, the LV image data is used for difference calculation of the region outside the region A12.

As described above, restrictions such as an area and a position may be set in a region where difference calculation is performed using RAW image data. For example, the respective restrictions on the region for which the difference calculation is performed using the RAW image data and the region for which the difference calculation is performed using the LV image data are set independently. The camera control unit 16 functions as a control unit that sets a restriction on each of a region for which difference calculation is performed using the RAW image data and a region for which difference calculation is performed using the LV image data.

In the example of FIG. 12, the region A12 is set at the center of the region A11, but the region A12 may be set at an arbitrary position in the region A11.

Furthermore, in the example of FIG. 12, the rectangular region A11 is detected as the moving object determination difficult region, but a region having a shape other than the rectangle may be detected as the moving object determination difficult region.
Example in which difference calculation of a region that is not a moving object determination difficult region is performed using RAW image data

The user may be allowed to designate a region for which the difference calculation is performed using the RAW image data. For example, even a region that is not a moving object determination difficult region can be designated as a region for which difference calculation is performed using RAW image data. The designated region, which is a region for which the difference calculation is performed using the RAW image data, is designated, for example, by touching the LV image displayed on the display of the imaging device 1.

It is expected that some users have regions where they want to ensure that pixel differences (moving objects) are absolutely not included among the users. By allowing the user to designate a region for which difference calculation is performed using the RAW image data, it is possible to meet the user's needs.

In consideration of the calculation load, the area of the designated region is limited to a predetermined area set as a threshold. In a case where the user designates a region having the same area as the area of the threshold as the designated region, the RAW image data is used for the difference calculation of the designated region. In a case where the moving object determination difficult region is included in a region other than the designated region in the same frame, the LV image data is used for the difference calculation of the moving object determination difficult region without using the RAW image data.

Furthermore, in a case where the user designates a region having an area of half (50%) the area of the threshold as the designated region, the RAW image data is used for the difference calculation of the designated region. In a case where the moving object determination difficult region is included in a region other than the designated region in the same frame, the RAW image data is used for difference calculation of an area of half the area of the threshold in the moving object determination difficult region.

As described above, in a case where the region designated by the user is wide, the region to be subjected to the difference calculation using the RAW image data in the moving object determination difficult region is narrowed, and in a case where the region designated by the user is narrow, the region to be subjected to the difference calculation using the RAW image data in the moving object determination difficult region is widened. Thus, the respective regions are set in a trade-off manner.

Data to be used for difference calculation may be determined depending on whether or not the region is a region designated by the user and whether or not the region is a moving object determination difficult region, such that RAW image data is used for difference calculation of a moving object determination difficult region included in the designated region. It is possible to use RAW image data for difference calculation of a region designated by the user and also being a moving object determination difficult region.

In a case where a moving object determination difficult region is included in a certain frame, RAW image data may be used for difference calculation of not only the moving object determination difficult region but also the entire frame.

The use of the RAW image data for the difference calculation of the entire frame may be performed in a case where the area of the moving object determination difficult region is equal to or larger than the area of the threshold. In this case, when the area of the moving object determination difficult region is equal to or larger than the area of the threshold, the difference calculation for the entire frame is performed using the RAW image data, and when the area is equal to or less than the area of the threshold, the difference calculation for the entire frame is performed using the LV image data.
Example of switching image data used for difference calculation

Although the data used for the difference calculation of the region in the same frame is switched between the LV image data and the RAW image data, the data used for the difference calculation may be switched in units of frames. For example, difference calculation for one entire frame is performed using the LV image data, and difference calculation for the next entire frame is performed using the RAW image data.

In this manner, the frame for which the difference calculation is performed using the LV image data and the frame for which the difference calculation is performed using the RAW image data may be periodically set. Performing the difference calculation by selectively switching the LV image data and the RAW image data includes switching the data used for the difference calculation in units of frames as described above.

### Example of Alert Display

The moving object detected by the difference calculation using the LV image data and the moving object detected by the difference calculation using the RAW image data may be presented by alert display in different modes.

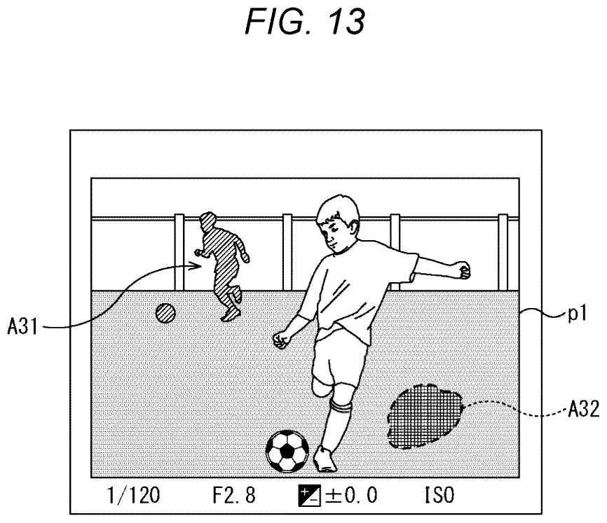

FIG. 13 is a diagram illustrating an example of alert display.

In the example of FIG. 13, a region A31 that is a region in which an upper left person appears and a region A32 in which a lower right lawn appears are detected as moving object regions. For example, the region A31 is a moving object region detected by difference calculation using the LV image data, and the region A32 is a moving object region detected by difference calculation using the RAW image data.

In this case, the alert display of the region A31 and the region A32 is performed using different colors. The region A31 and the region A32 are indicated by different hatches, which indicates that the respective regions are displayed in different colors.

The alert display of each moving object region may be performed by changing information other than color, such as changing the type of contour line (straight line, broken line, or the like). The alert display of each moving object region can be performed by changing at least one of the color or the type of the contour line.

As a result, the user can confirm which algorithm of the difference calculation using the LV image data and the difference calculation using the RAW image data is used to detect the moving object region.

The threshold and the range of alert display described above may be set for each algorithm. The user can perform setting such that the difference calculation of the range regarded as important is performed using the RAW image data.

### Presentation of Camera Shake State

Camera shake information that is information indicating a state of camera shake may be displayed on the UI screen.

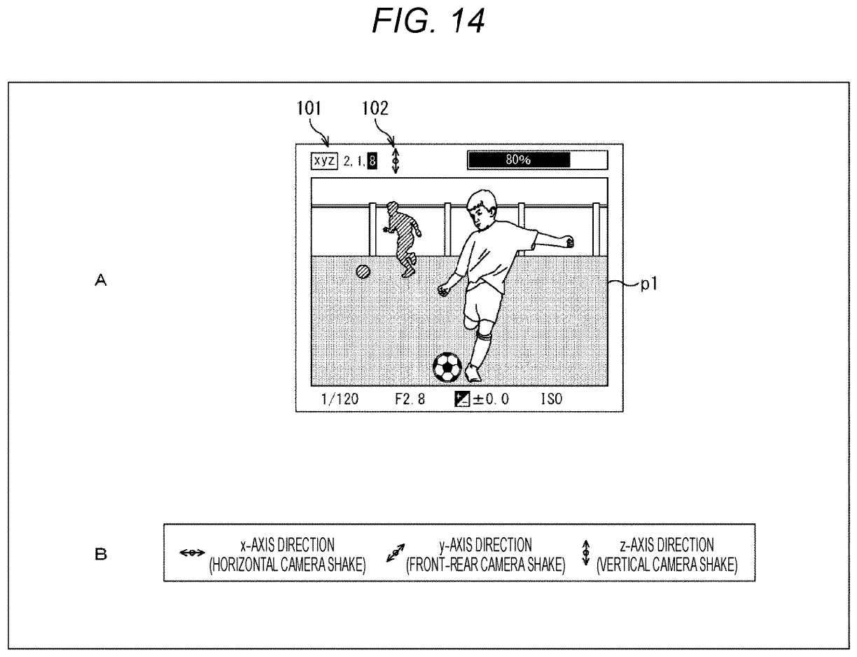

FIG. 14 is a diagram illustrating an example of camera shake information.

In the example in A of FIG. 14, a camera shake alert 101 is displayed at the upper left of the UI screen. The numbers “2, 1, 8” constituting the camera shake alert 101 indicate that the camera shake amounts in the respective directions of the x-axis direction, the y-axis direction, and the z-axis direction are amounts represented by “2”, “1”, and “8”. The camera shake amount in each axial direction is normalized and presented to the user.

For example, in a case where a camera shake amount equal to or larger than a threshold set by the user is measured on the basis of sensor data output from the sensor unit 15, a number indicating the camera shake amount is emphasized. The number “8” emphasized in A of FIG. 14 indicates that the camera shake amount in the z-axis direction is equal to or larger than the threshold.

An icon 102 displayed on the right side of the camera shake alert 101 indicates the direction of the camera shake. A direction of an arrow constituting the icon 102 indicates a direction of camera shake as illustrated in B of FIG. 14.

By presenting the state of the camera shake, the user can readjust their hold on the imaging device 1 so as to suppress the camera shake.

### Others

Although the information processing device that performs difference calculation by selectively switching between the LV image data and the RAW image data is assumed to be a camera (imaging device 1), the above-described technology can be applied to other information processing devices having imaging functions, such as a smartphone.

Furthermore, in a server that controls the operation of the imaging device, the difference calculation may be performed by selectively switching the LV image data and the RAW image data.

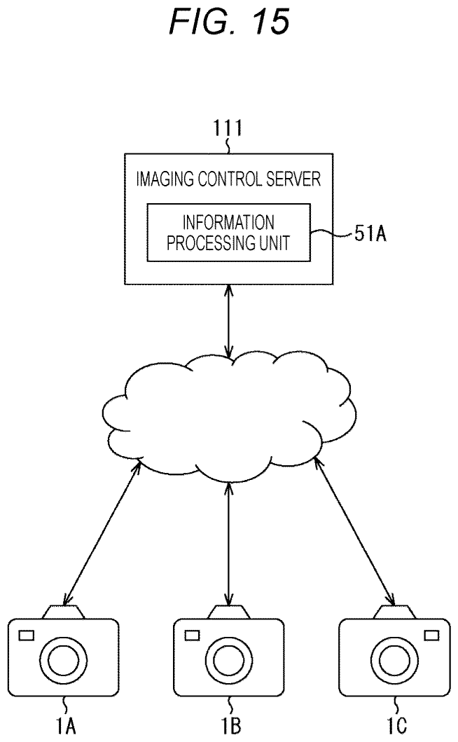

FIG. 15 is a diagram illustrating a configuration example of an imaging control system.

An imaging control server 111 illustrated in FIG. 15 is an information processing device that controls operation of each of imaging devices 1A to 1C via a network such as the Internet. In this case, the information processing unit 51A described with reference to FIG. 10 is implemented in the imaging control server 111.

The difference processing unit 81 of the information processing unit 51A performs difference calculation at the time of continuous imaging in each of the imaging devices 1A to 1C by selectively switching between the LV image data and the RAW image data. In a case where a moving object is included, the display control unit 82 performs alert display using the display of each of the imaging devices 1A to 1C.

In this manner, processing similar to the processing described above may be performed in a server on the network. The combining processing of the plurality of RAW images obtained by the continuous imaging may be performed in the imaging device 1 instead of the external PC.

Although the difference calculation is performed by selectively switching the LV image data and the RAW image data, the image data of any format may be used for the difference calculation instead of the LV image data as long as the image has a smaller information amount than the RAW image. That is, developed images in various formats generated by development processing based on RAW images can be used for difference calculation.

In addition, as long as the image has a larger information amount than the developed image, image data in any format may be used for difference calculation instead of the RAW image data.

As described above, every time an image of each frame is captured, two types of images, that is, an image in a first format with a large amount of information and an image in a second format with a small amount of information, corresponding to the image of each frame are generated in the imaging device 1, and the data thereof is selectively switched to perform difference calculation. In other words, the image in the first format and the image in the second format corresponding to each of the reference frame and the target frame are generated, and the pixel difference of the target frame with respect to the reference frame is calculated by selectively calculating the first pixel difference that is the difference between the data of the images in the first format and the second pixel difference that is the difference between the data of the images in the second format.
Regarding program

The above-described series of processing can be executed by hardware or software. In a case where the series of processing is executed by software, a program constituting the software is installed in a computer incorporated in dedicated hardware, a general-purpose personal computer, or the like.

The program to be installed is provided by being recorded in the removable medium 61 illustrated in FIG. 10, including an optical disc (compact disc-read only memory (CD-ROM), a digital versatile disc (DVD), and the like), a semiconductor memory, or the like. Furthermore, the information may be provided via a wired or wireless transmission medium such as a local area network, the Internet, or digital broadcasting. The program can be installed in the ROM 52 or the recording unit 58 in advance.

The program executed by the computer may be a program in which processing is performed in time series in the order described in the present specification, or may be a program in which processing is performed in parallel or at necessary timing such as when a call is made.

In the present specification, a system means a set of a plurality of components (devices, modules (parts), or the like), and it does not matter whether or not all the components are in the same housing. Therefore, a plurality of devices housed in separate housings and connected via a network and one device in which a plurality of modules is housed in one housing are both systems.

Note that the effects described in the present specification are merely examples and are not limited, and other effects may be provided.

The embodiments of the present technology are not limited to the above-described embodiments, and various modifications can be made without departing from the gist of the present technology.

For example, the present technology can have a configuration of cloud computing in which one function is shared and processed in cooperation by a plurality of devices via a network.

Furthermore, each step described in the above-described flowcharts can be executed by one device or can be shared and executed by a plurality of devices.

Furthermore, in a case where a plurality of processes is included in one step, the plurality of processes included in the one step can be executed by one device or can be shared and executed by a plurality of devices.
Example of combination of configurations

The present technology can also have the following configurations.
(1)

An information processing device including
an image processing unit that calculates a pixel difference of a target frame with respect to a reference frame by selectively calculating a first pixel difference that is a difference between data of an image in a first format corresponding to the reference frame and data of an image in the first format corresponding to the target frame, and a second pixel difference that is a difference between data of an image in a second format having a smaller amount of information than the image in the first format corresponding to the reference frame and data of an image in the second format corresponding to the target frame.
(2)

The information processing device according to (1), further including
a display control unit that displays alert information indicating a moving object region that is a region in which a moving object appears on the basis of a pixel difference of the target frame.
(3)

The information processing device according to (2),
in which the display control unit causes the alert information to be displayed by superimposing the alert information on an LV image that is an image in the second format corresponding to the target frame.
(4)

The information processing device according to (2),
in which the display control unit causes the alert information based on the first pixel difference and the alert information based on the second pixel difference to be displayed in different modes.
(5)

The information processing device according to (4),
in which the display control unit causes the alert information to be displayed in a mode in which at least one of a color or a contour line indicating the moving object region is different.
(6)

The information processing device according to any one of (1) to (5), further including
a control unit that sets a limit of a range for each of a region for calculating the first pixel difference and a region for calculating the second pixel difference.
(7)

The information processing device according to any one of (1) to (6),
in which the image processing unit calculates a pixel difference of the target frame by mixing a region for calculating the first pixel difference and a region for calculating the second pixel difference.
(8)

The information processing device according to any one of (1) to (7),
in which the image processing unit determines whether to calculate the first pixel difference or the second pixel difference on the basis of a predetermined condition.
(9)

The information processing device according to (8),
in which the image processing unit determines whether to calculate the first pixel difference or the second pixel difference on the basis of whether or not a moving object determination difficult region is included in the target frame as the predetermined condition.
(10)

The information processing device according to (9),
in which the moving object determination difficult region is a region including a pixel including at least one of a high-frequency component, a strong edge component, or a high luminance component.
(11)

The information processing device according to (9) or (10),
in which in a case where the moving object determination difficult region is included in the target frame, the image processing unit calculates the pixel difference of the target frame by calculating the first pixel difference.
(12)

The information processing device according to (8),
in which the image processing unit calculates the first pixel difference as a pixel difference of the moving object determination difficult region among pixel differences of the target frame.
(13)

The information processing device according to (8),
in which the image processing unit determines whether to calculate the first pixel difference or the second pixel difference on the basis of whether or not an area of a moving object determination difficult region in the target frame is equal to or larger than a threshold as the predetermined condition.
(14)

The information processing device according to (13),
in which in a case where the area of the moving object determination difficult region is equal to or larger than the threshold, the image processing unit calculates the first pixel difference in a region having an area within the threshold in the moving object determination difficult region, and calculates the second pixel difference in other regions.
(15)

The information processing device according to (13),
in which the image processing unit calculates a pixel difference of the target frame by using only the first pixel difference in a case where the area of the moving object determination difficult region is equal to or larger than the threshold, and calculates the pixel difference of the target frame by using only the second pixel difference in a case where the area is equal to or less than the threshold.
(16)

The information processing device according to (8),
in which the image processing unit determines whether to calculate the first pixel difference or the second pixel difference on the basis of, as the predetermined condition, whether or not a region as a calculation target of a pixel difference of the target frame includes a region in a designated region that is a region designated by a user.
(17)

The information processing device according to (16),
in which the image processing unit calculates the pixel difference of the target frame by calculating the first pixel difference in the designated region in the target frame.
(18)

The information processing device according to (8),
in which the image processing unit determines whether to calculate the first pixel difference or the second pixel difference on the basis of, as the predetermined condition, whether or not a moving object determination difficult region is included in the target frame and whether or not the moving object determination difficult region is included in a designated region.
(19)

The information processing device according to (18),
in which the image processing unit calculates the first pixel difference in a case where the moving object determination difficult region is included in the designated region.
(20)

The information processing device according to (19),
in which the image processing unit calculates a pixel difference of the target frame by calculating the first pixel difference of the moving object determination difficult region in the designated region.
(21)

The information processing device according to any one of (2) to (20), further including
a control unit that records metadata including information indicating a moving object determination difficult region and information indicating the moving object region in association with the image captured in the first format.
(22)

The information processing device according to any one of (2) to (21), further including
a control unit that performs continuous imaging of the image in the first format until the number of captured images reaches a target number of captured images.
(23)

The information processing device according to (22), further including
a captured number determination unit that determines the target number of captured images on the basis of a pixel coverage of the image captured in the first format or on the basis of a coverage of an exposure level.
(24)

The information processing device according to (22) or (23),
in which the display control unit causes information indicating a progress status with respect to the target number of captured images to be displayed.
(25)

The information processing device according to any one of (22) to (24),
in which the control unit causes the continuous imaging to be performed until the number of captured images of the image in the first format in which no moving object is present reaches the target number of captured images.
(26)

An information processing method in which
an information processing device is configured to
calculate a pixel difference of a target frame with respect to a reference frame by selectively calculating a first pixel difference that is a difference between data of an image in a first format corresponding to the reference frame and data of an image in the first format corresponding to the target frame, and a second pixel difference that is a difference between data of an image in a second format having a smaller amount of information than the image in the first format corresponding to the reference frame and data of an image in the second format corresponding to the target frame.
(27)

A program for causing a computer
to execute processing of
calculating a pixel difference of a target frame with respect to a reference frame by selectively calculating a first pixel difference that is a difference between data of an image in a first format corresponding to the reference frame and data of an image in the first format corresponding to the target frame, and a second pixel difference that is a difference between data of an image in a second format having a smaller amount of information than the image in the first format corresponding to the reference frame and data of an image in the second format corresponding to the target frame.

### Reference Signs List

1 Imaging device
11 Optical system
12 Imaging element
13 Image processing unit
13A Difference processing unit
13B Captured number calculation unit
14 Recording unit
15 Sensor unit
16 Camera control unit
17 Display unit
18 Operation unit
51 CPU
51A Information processing unit
81 Difference processing unit
82 Display control unit

1. An information processing device comprising
an image processing unit that calculates a pixel difference of a target frame with respect to a reference frame by selectively calculating a first pixel difference that is a difference between data of an image in a first format corresponding to the reference frame and data of an image in the first format corresponding to the target frame, and a second pixel difference that is a difference between data of an image in a second format having a smaller amount of information than the image in the first format corresponding to the reference frame and data of an image in the second format corresponding to the target frame.

2. The information processing device according to claim 1, further comprising
a display control unit that displays alert information indicating a moving object region that is a region in which a moving object appears on a basis of a pixel difference of the target frame.

3. The information processing device according to claim 2,
wherein the display control unit causes the alert information to be displayed by superimposing the alert information on an LV image that is an image in the second format corresponding to the target frame.

4. The information processing device according to claim 2,
wherein the display control unit causes the alert information based on the first pixel difference and the alert information based on the second pixel difference to be displayed in different modes.

5. The information processing device according to claim 4,
wherein the display control unit causes the alert information to be displayed in a mode in which at least one of a color or a contour line indicating the moving object region is different.

6. The information processing device according to claim 1, further comprising
a control unit that sets a limit of a range for each of a region that calculates the first pixel difference and a region that calculates the second pixel difference.

7. The information processing device according to claim 1,
wherein the image processing unit calculates a pixel difference of the target frame by mixing a region that calculates the first pixel difference and a region that calculates the second pixel difference.

8. The information processing device according to claim 1,
wherein the image processing unit determines whether to calculate the first pixel difference or the second pixel difference on a basis of a predetermined condition.

9. The information processing device according to claim 8,
wherein the image processing unit determines whether to calculate the first pixel difference or the second pixel difference on a basis of whether or not a moving object determination difficult region is included in the target frame as the predetermined condition.

10. The information processing device according to claim 9,
wherein the moving object determination difficult region is a region including a pixel including at least one of a high-frequency component, a strong edge component, or a high luminance component.

11. The information processing device according to claim 9,
wherein in a case where the moving object determination difficult region is included in the target frame, the image processing unit calculates the pixel difference of the target frame by calculating the first pixel difference.

12. The information processing device according to claim 8,
wherein the image processing unit calculates the first pixel difference as a pixel difference of the moving object determination difficult region among pixel differences of the target frame.

13. The information processing device according to claim 8,
wherein the image processing unit determines whether to calculate the first pixel difference or the second pixel difference on a basis of whether or not an area of a moving object determination difficult region in the target frame is equal to or larger than a threshold as the predetermined condition.

14. The information processing device according to claim 13,
wherein in a case where the area of the moving object determination difficult region is equal to or larger than the threshold, the image processing unit calculates the first pixel difference in a region having an area within the threshold in the moving object determination difficult region, and calculates the second pixel difference in other regions.

15. The information processing device according to claim 13,
wherein the image processing unit calculates a pixel difference of the target frame by using only the first pixel difference in a case where the area of the moving object determination difficult region is equal to or larger than the threshold, and calculates the pixel difference of the target frame by using only the second pixel difference in a case where the area is equal to or less than the threshold.

16. The information processing device according to claim 8,
wherein the image processing unit determines whether to calculate the first pixel difference or the second pixel difference on a basis of, as the predetermined condition, whether or not a region as a calculation target of a pixel difference of the target frame includes a region in a designated region that is a region designated by a user.

17. The information processing device according to claim 16,
wherein the image processing unit calculates the pixel difference of the target frame by calculating the first pixel difference in the designated region in the target frame.

18. The information processing device according to claim 8,
wherein the image processing unit determines whether to calculate the first pixel difference or the second pixel difference on a basis of, as the predetermined condition, whether or not a moving object determination difficult region is included in the target frame and whether or not the moving object determination difficult region is included in a designated region.

19. An information processing method in which
an information processing device is configured to
calculate a pixel difference of a target frame with respect to a reference frame by selectively calculating a first pixel difference that is a difference between data of an image in a first format corresponding to the reference frame and data of an image in the first format corresponding to the target frame, and a second pixel difference that is a difference between data of an image in a second format having a smaller amount of information than the image in the first format corresponding to the reference frame and data of an image in the second format corresponding to the target frame.

20. A program for causing a computer
to execute processing of
calculating a pixel difference of a target frame with respect to a reference frame by selectively calculating a first pixel difference that is a difference between data of an image in a first format corresponding to the reference frame and data of an image in the first format corresponding to the target frame, and a second pixel difference that is a difference between data of an image in a second format having a smaller amount of information than the image in the first format corresponding to the reference frame and data of an image in the second format corresponding to the target frame.
